(19) United States
(12) Patent Application Publication
(10) Pub. No.: US 2023/0142379 A1
(43) Pub. Date: May 11, 2023

(54) Connector

(71) Applicant: Tyco Electronics Japan G.K., Kawasaki-shi (JP)

(72) Inventor: Kazuhiro Mizukami, Kawasaki-shi (JP)

(73) Assignee: Tyco Electronics Japan G.K., Kawasaki-shi (JP)

(21) Appl. No.: 18/148,750

(22) Filed: Dec. 30, 2022

Related U.S. Application Data
(63) Continuation of application No. PCT/JP21/23259, filed on Jun. 18, 2021.

(30) Foreign Application Priority Data
Jul. 3, 2020 (JP) 2020-115360

(51) Int. Cl. H01R 24/40; H01R 13/40; H01R 12/71; H01R 13/516; H01R 13/508

(52) U.S. Cl. CPC H01R 24/40; H01R 13/40; H01R 12/712; H01R 13/516; H01R 13/508; H01R 2103/00

(57) ABSTRACT

A connector includes a housing having an accommodation space with an opening on a front surface facing a mating connector side and a rear surface facing away from the mating connector side, an outer shell covering the housing including the rear surface of the housing, a contact accommodated in the accommodation space, and an inner shell positioned in the accommodation space and covering the contact. A spring portion that elastically presses the inner shell forward is provided between a portion of the outer shell along the rear surface of the housing and the inner shell.

### CROSS-REFERENCE TO RELATED APPLICATIONS

This application is a continuation of PCT International Application No. PCT/JP2021/023259, filed on Jun. 18, 2021, which claims priority under 35 U.S.C. § 119 to Japanese Patent Application No. 2020-115360, filed on Jul. 3, 2020.

### FIELD OF THE INVENTION

The present invention relates to a connector suited for transmission of high frequency signals.

### BACKGROUND

In the transmission of high frequency signals, reflection of the signal or the like easily occurs, and realizing satisfactory transmission characteristics becomes a concern. In particular, satisfactory transmission characteristics over a wide band of high frequency is required for the transmission of video signals.

JP 8-222325A discloses an invention in which flat coaxial cable ends, where a plurality of coaxial cables are gathered, are collectively connected to a circuit ground and a frame ground by way of a common electrically conductive member. The invention of JP 8-222325A aims to eliminate the occurrence of potential variation and occurrence of impedance discontinuity of the ground side wiring.

There is a need for a connector having satisfactory transmission characteristics over a wide band of high frequency.

### SUMMARY

A connector includes a housing having an accommodation space with an opening on a front surface facing a mating connector side and a rear surface facing away from the mating connector side, an outer shell covering the housing including the rear surface of the housing, a contact accommodated in the accommodation space, and an inner shell positioned in the accommodation space and covering the contact. A spring portion that elastically presses the inner shell forward is provided between a portion of the outer shell along the rear surface of the housing and the inner shell.

### BRIEF DESCRIPTION OF THE DRAWINGS

The invention will now be described by way of example with reference to the accompanying Figures, of which:

FIG. 1 is an isometric view of a connector according to an embodiment of the invention;

FIG. 2 is an exploded isometric view of the connector of FIG. 1;

FIG. 3A is an isometric view showing the connector in a direction in which a lower surface appears;

FIG. 3B is a rear view of the connector;

FIG. 4A is a sectional side view taken along arrow A-A of FIG. 1;

FIG. 4B is a sectional perspective view taken along arrow A-A of FIG. 1;

FIG. 5A is a side view of a front shell and a back shell of the connector, where the back shell abuts on the front shell;

FIG. 5B is a side view of the front shell and the back shell, with a slight gap formed between the back shell and the front shell;

FIG. 5C is graph of a measurement result of an insertion loss;

FIG. 5D is a graph of a measurement result of a voltage standing wave ratio;

FIG. 6A is a side view of the front shell and the back shell of the connector, where the back shell abuts on the front shell;

FIG. 6B is a side view of the front shell and the back shell, with a slight gap formed between the back shell and the front shell;

FIG. 6C is a graph of a measurement result of an impedance;

FIG. 6D is a graph is a measurement result of screening attenuation characteristics;

FIG. 7A is a side view of an inner shell according to another embodiment with the back shell in an open posture; and

FIG. 7B is a side view of the inner shell with the back shell in a pushed state against the front shell.

### DETAILED DESCRIPTION OF THE EMBODIMENTS

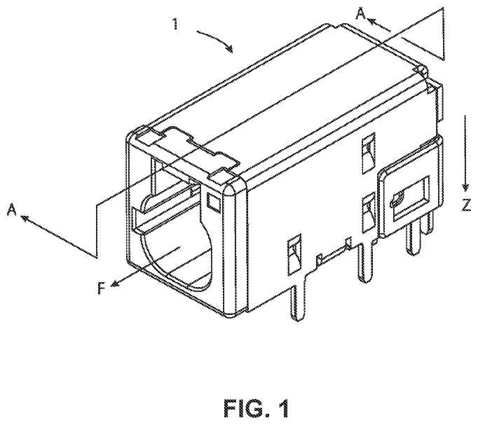

FIG. 1 is an isometric view of a connector according to one embodiment of the invention.

The connector 1 is a connector in which a forward side indicated with an arrow F is directed toward a mating connector to be mated with the mating connector. Furthermore, the connector 1 is mounted on a circuit board positioned on a lower side indicated with an arrow Z and soldered to the circuit board.

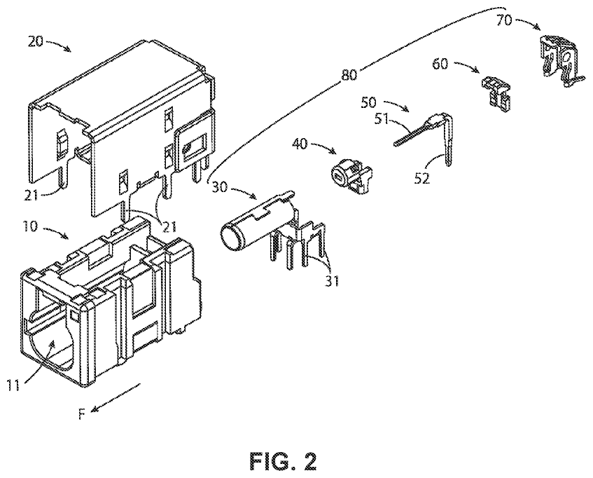

FIG. 2 is an exploded isometric view of the connector, whose isometric view is illustrated in FIG. 1. As shown in FIG. 2, the connector 1 includes an outer housing 10 and an outer shell 20.

The outer housing 10 is formed with an accommodation space 11. The accommodation space 11 is formed with an opening on a front surface facing the mating connector side (facing the direction of the arrow F) and the rear surface facing away from the mating connector. The outer housing 10 corresponds to an example of a housing in the invention.

In an embodiment, the outer shell 20 is provided for shielding, and has a shape that covers an upper surface, left and right side surfaces, and a rear surface of the outer housing 10. The outer shell 20 is provided with a plurality of pin-shaped solder connecting portions 21 extending downward to be solder connected to the circuit board.

As shown in FIG. 2, the connector 1 includes a front shell 30, a front housing 40, a pin 50, a back housing 60, and a back shell 70.

The pin 50, also referred to as a contact, includes a first extended portion 51 extending in a front-back direction, and a second extended portion 52 bent and extended downward from a back end of the first extended portion 51. The first extended portion 51 comes into contact with and electrically conducts with a contact of a mating connector mated with the connector 1. The second extended portion 52 is solder-connected to a circuit board positioned below. The pin 50 corresponds to an example of a contact in the present invention.

The front housing 40 and the back housing 60 support the pin 50 so as to sandwich the pin 50 from the front side and the back side. A configuration combining the front housing 40 and the back housing 60 in the present embodiment corresponds to an example of an inner housing of the invention.

In an embodiment, the front shell 30 and the back shell 70 cover the pin 50 with the front housing 40 and the back housing 60 in between, and shield the pin 50. The front shell 30 is formed with six pin-shaped solder-connecting portions 31 extended downward and solder-connected to the circuit board. In the present embodiment, a configuration combining the front shell 30 and the back shell 70 corresponds to an example of an inner shell in the present invention.

An assembly including the front shell 30, the front housing 40, the pin 50, the back housing 60, and the back shell 70 is referred to as a “sub-assembly 80”, shown in FIG. 2. The sub-assembly 80 is inserted into a main housing 10 from a rear surface side of the main housing 10. The sub-assembly 80 is inserted into the main housing 10, and the outer shell 20 is placed thereon to complete the connector 1 shown in FIG. 1.

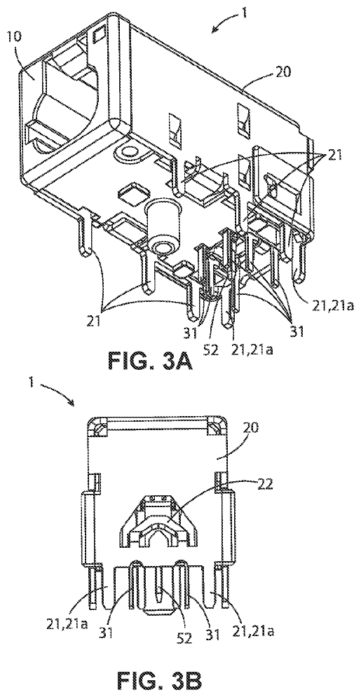

FIG. 3A shows the second extended portion 52 of the pin 50, a plurality of solder-connecting portions 21 of the outer shell 20, and a plurality of (six) solder-connecting portions 31 of the front shell 30. Among them, the second extended portion 52 of only one pin 50 is for signal transmission. The other plurality of solder-connecting portions 21 of the outer shell 20 and the six solder-connecting portions 31 of the front shell 30 are for fixing the connector 1 to the circuit board, and are also for electrically grounding. In particular, eight portions, the two solder-connecting portions 21a of the plurality of solder-connecting portions 21 of the outer shell 20 and the six solder-connecting portions 31 of the front shell 30, are responsible for grounding. Such eight solder-connecting portions 21a, 31 are positioned to surround the second extended portion 52 of the pin 50.

FIG. 3B shows a raised piece 22, which is a feature of the present embodiment. The raised piece 22 corresponds to an example of a spring portion and an example of a raised piece in the present invention. The raised piece 22 is provided in a region facing the rear surface of the outer housing 10 of the outer shell 20, and has a shape raised toward the front side, that is, in a direction of an arrow F shown in FIGS. 1 and 2. Furthermore, the spring portion can be configured with a simple structure by providing such a raised piece 22 regardless of whether the raised piece 22 is on the outer shell 20 or on the inner shell 30.

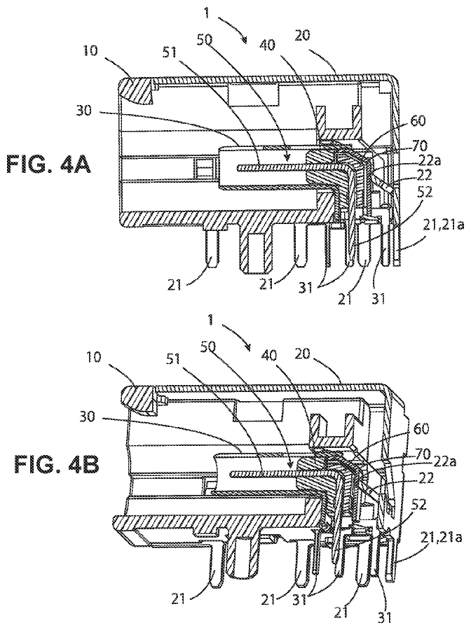

The operations of the raised piece 22 will be described below with reference to FIG. 4. The raised piece 22 is elastically bent by abutting on the inner shell 30. The raised piece 22 abuts on the inner shell 30 at a position below the first extended portion 51 in an up-down direction.

The inner shell 30 has a shape of covering the contact 50. Therefore, the position of the center of gravity of the inner shell 30 in the up-down direction is at a position below the first extended portion 51. Thus, the entire inner shell 30 can be pressed forward in a balanced manner by abutting the raised piece 22 at a position below the first extended portion 51 in the up-down direction than by abutting the raised piece 22 at a position the same height as or above the first extended portion 51.

As shown in FIGS. 4A and 4B, the raised piece 22 is raised at an angle of 45° with respect to the up-down direction in the present embodiment so as to collapse forward (direction of the arrow F shown in FIGS. 1 and 2). Then, a distal end portion 22a of the raised piece 22 butts against the back shell 70. In FIGS. 4A and 4B, the raised piece 22 is shown so as to bite into the back shell 70, but this is to show the shape before deformation in design as is. In fact, the raised piece 22 butts against the back shell 70 and elastically deforms, and pushes the back shell 70 forward (direction of the arrow F). The back shell 70 is pushed by the raised piece 22, and abuts on the front shell 30 so as not to form even a slight gap with the front shell 30. In another embodiment, the raised piece 22 is raised at an angle smaller than 45° with respect to the up-down direction.

The raised piece 22 abuts on the back shell 70 at a position below the first extended portion 51 extending in the front-back direction of the pin 50 in the up-down direction. Since the second extended portion 52 of the pin 50 extends downward from the first extended portion 51, the back shell 70 is also greatly spread toward the lower side from the first extended portion 51, and the center of gravity of the back shell 70 is located on the lower side of the first extended portion 51. Therefore, the entire back shell 70 is pushed against the front shell 30 in a balanced manner by abutting the raised piece 22 on the back shell 70 at a position below the first extended portion 51.

In the present embodiment, the spring portion in the present invention can be realized with a simple structure by forming such raised piece 22.

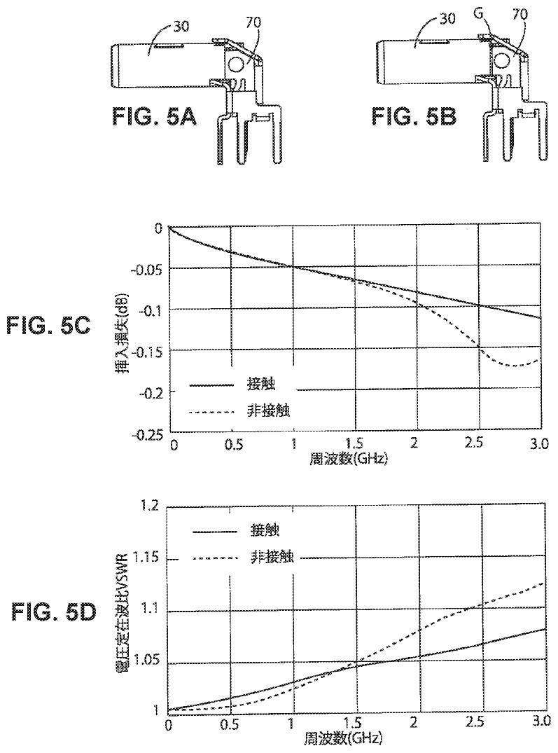

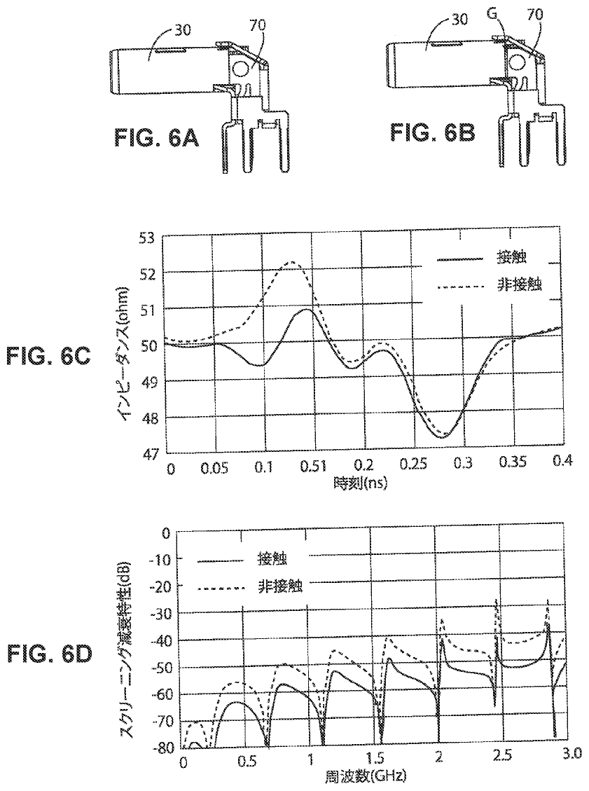

FIGS. 5A-6D show experiment results.

FIGS. 5A and 6A show the front shell 30 and the back shell 70 in a state where the back shell 70 is abuts on the front shell 30, and corresponds to one example of the invention. FIGS. 5B and 6B show the front shell 30 and the back shell 70 in a state where the raised piece 22, shown in FIGS. 4A and 4B, does not exist and a slight gap G is formed between the back shell 70 and the front shell 30. The embodiment shown in FIGS. 5B and 6B corresponds to a comparative example with respect to the present invention.

FIG. 5C is a graph showing a measurement result of an insertion loss (dB). The insertion loss (dB) may be closer to 0 dB, and an example in which the back shell 70 is in contact with the front shell 30 is more satisfactory in a high frequency region, in particular, 2.0 to 3.0 GHz as compared with a comparative example in which the back shell 70 is not in contact with the front shell 30.

Furthermore, FIG. 5D is a graph showing a measurement result of a voltage standing wave ratio (VSWR) on the circuit board side. The voltage standing wave ratio (VSWR) may be closer to 1, and the example of FIG. 5A is more satisfactory particularly in the high frequency region.

FIG. 6C is a graph of a measurement result of an impedance on the circuit board side. The impedance may be always stable at 50 ohm, and the example of FIG. 6A is more satisfactory regarding the impedance. In addition, FIG. 6D is a graph showing a measurement result of screening attenuation characteristics. The screening attenuation characteristics may be low, and the example of FIG. 6A is more satisfactory regarding the screening attenuation characteristics as well.

The connector 1 of the present embodiment forms the raised piece 22 on the outer shell 20, and pushes the back shell 70 forward to push the back shell 70 against the front shell 30. Thus, the connector 1 of the present embodiment realizes satisfactory signal transmission characteristics as compared with a case where the raised piece 22 does not exist.

In the present embodiment, the raised piece 22 is raised at an angle of 45° with respect to the up-down direction. Thus, in the present embodiment, the balance between the signal transmission characteristics and the ensuring of the pressing force of the back shell 70 against the front shell 30 is maintained.

However, the raised piece 22 does not necessarily need to be raised at an angle of 45°. For example, the raised piece 22 may be raised at an angle smaller than 45° with respect to the up-down direction. The raised piece 22 abuts on the back shell 70 at a position of the pin 50 where the second extended portion 52 extending in the up-down direction exists in the height direction. When raised at an angle smaller than 45°, the raised piece 22 approaches to be parallel to the second extended portion 52 of the pin 50 as compared with a case where the raised piece is raised at an angle of 45°. Therefore, further improvement in the signal transmission characteristics can be expected.

Alternatively, the raised piece 22 may be raised at an angle larger than 45°. In this case, the spring force can be increased and the back shell 70 can be pushed stronger than when the raised piece 22 is raised at an angle of 45°. Therefore, the back shell 70 can be strongly pushed against the front shell 30, and the back shell 70 and the front shell 30 can be more strongly adhered.

Furthermore, in the present embodiment, the raised piece 22 is provided on the outer shell 20. The raised piece 22 is a raised piece that is raised obliquely toward the front side and elastically bent by abutting on the back shell 70. However, in place of the raised piece 22, a raised piece that is provided on the back shell 70 and raised toward the back side, and elastically bent by abutting on the outer shell 20, may be provided. In the case of such a configuration as well, the back shell 70 can be elastically pushed against the front shell 30.

The inner shell 90 is considered to have a structure of being separated into a plurality of portions or being partially separated even if connected to one portion in terms of the necessity of positioning the contact 50 on the inner side and covering the contact 50. In this case, the inner shell 90 may be partially formed with a gap, described below, when pressing is not carried out or may be formed with a portion that is not sufficiently in contact.

In the connector 1, the spring portion 22 is provided, and the inner shell 90 is elastically pressed forward. Therefore, even with the inner shell 90 having a structure in which the gap is formed when pressing is not carried out or a portion that is not sufficiently in contact is formed, the gap is filled or sufficient contact is obtained, and satisfactory transmission characteristics over a wide band of high frequency is realized.

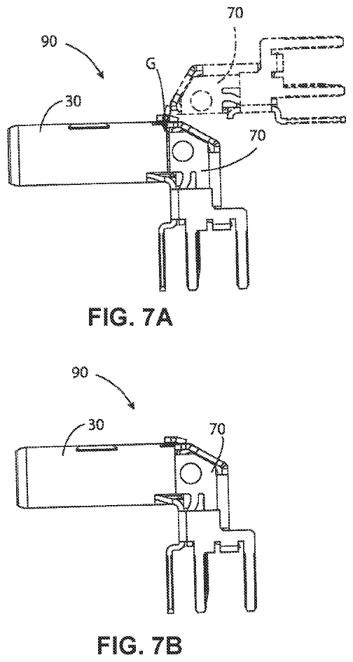

FIGS. 7A and 7B show an inner shell 90 according to another embodiment Here, for the sake of easy understanding, a portion corresponding to the front shell 30 and the back shell 70 in the embodiment described above in the inner shell 90 is referred to as the front shell 30 and the back shell 70 herein.

Even when the inner shell 90 having the structure shown in FIG. 7 is adopted, the structure of each portion other than the inner shell 90 follows those in the embodiment described above.

The inner shell 90 shown in FIGS. 7A and 7B includes the front shell 30 and the back shell 70, which are separated from or partially coupled to each other. Thus, with the inner shell 90 including the front shell 30 and the back shell 70, which are of a partially coupled structure, the number of components are reduced as compared with when the front shell and the back shell are separated from each other, which is advantageous in terms of assembly and cost. The front shell 30 and the back shell 70 cover the contact 50 to sandwich the contact 50 from front side and back side.

The contact 50, as well as an inner housing including the front housing 40 and the back housing 60 that supports the contact 50, need to be inserted inside the inner shell 90. Thus, at the time point of insertion, the back shell 70 is set to an open posture as shown with a chain line in FIG. 7A with respect to the front shell 30. After the contact 50 and the inner housing (front housing 40 and back housing 60) are inserted, the back shell 70 is in a posture indicated with a solid line in FIG. 7A. If the back shell 70 remained in the posture indicated with the solid line, the gap G tends to remain and is formed between the front shell 30 and the back shell 70.

The back shell 70 is pressed forward by the raised piece 22 (see FIGS. 3 and 4), so that the back shell 70 is pushed against the front shell 30. FIG. 7B shows the inner shell 90 in a pushed state. This pushing electrically integrates the front shell 30 and the back shell 70, and satisfactory signal transmission characteristics as shown in FIGS. 5 and 6 can be obtained.

What is claimed is:

1. A connector, comprising:
a housing having an accommodation space with an opening on a front surface facing a mating connector side and a rear surface facing away from the mating connector side;
an outer shell covering the housing including the rear surface of the housing;
a contact accommodated in the accommodation space, the contact capable of forming an electrical connection with a mating connector; and
an inner shell positioned in the accommodation space and covering the contact, a spring portion that elastically presses the inner shell forward is provided between a portion of the outer shell along the rear surface of the housing and the inner shell.

2. The connector according to claim 1, wherein the inner shell includes a front shell and a back shell separated from or partially coupled to each other.

3. The connector according to claim 2, wherein the front shell and the back shell cover the contact and sandwich the contact from a front side and a back side.

4. The connector according to claim 1, wherein the spring portion is a raised piece provided on the outer shell and raised obliquely forward.

5. The connector according to claim 4, wherein the raised piece is elastically bent by abutting on the inner shell.

6. The connector according to claim 5, wherein the contact has a first extended portion extending in a front-back direction for electrically connecting with the mating connector, and a second extended portion bent and extending downward from a back end of the first extended portion, the second extended portion is connected to a circuit board.

7. The connector according to claim 6, wherein the raised piece abuts on the back shell at a position below the first extended portion in an up-down direction.

8. The connector according to claim 7, wherein the raised piece is raised at an angle of 45° with respect to the up-down direction.

9. The connector according to claim 7, wherein the raised piece is raised at an angle smaller than 45° with respect to the up-down direction.

10. The connector according to claim 7, wherein the raised piece is raised at an angle larger than 45° with respect to the up-down direction.

11. The connector according to claim 1, further comprising an inner housing positioned in the accommodation space and supporting the contact.

12. The connector according to claim 11, wherein the inner shell covers the contact and the inner housing is positioned between the inner shell and the contact.

13. A connector, comprising:
a housing having an accommodation space, a front surface, and a rear surface;
an outer shell covering the housing;
a contact disposed in the accommodation space; and
an inner shell positioned in the accommodation space and covering the contact, a spring portion that elastically presses the inner shell in a direction toward the front surface of the housing is formed by a portion of the outer shell or by the inner shell.
